(19) United States
(12) Patent Application Publication
(10) Pub. No.: US 2003/0046178 A1
(43) Pub. Date: Mar. 6, 2003

(54) Method of e-payment for purchase

(76) Inventor: Wen-Chung Chao, Yunghe City (TW)

Correspondence Address: BACON & THOMAS, PLLC, 625 SLATERS LANE, FOURTH FLOOR, ALEXANDRIA, VA, 22314

(21) Appl. No.: 09/946,637

(22) Filed: Sep. 6, 2001

(51) Int. Cl. G06F 17/60

(52) U.S. Cl. 705/26

(57) ABSTRACT

An e-payment method for purchase, which applies to a shopping through a merchandise provider and telecommunication service provider connected with each other. First, a user has to apply to become a member of the telecommunication service provider and get a transmission number offered by the telecommunication service provider. The user can send the transmission number to the telecommunication service provider when the user selects products or services offered by the merchandise provider. Then telecommunication service provider will send a confirmation briefing to a display interface of the user's bidirectional wireless communication equipment after receives the user's transmission number. The user checks the confirmation briefing and sends a re-confirmation message back to the telecommunication service provider. The telecommunication service provider will list the cost of the selected product or service in a phone bill and complete the whole e-payment process.

### BACKGROUND OF THE INVENTION

1. Field of the Invention

The invention relates to an e-payment method for purchase, more particularly to a method that bi-directionally transmittable wireless communication equipment is used to offer a safe and convenient environment of purchase. Besides, Internet, a regular store and non-store can offer the same environment of purchase by using the method of the invention.

2. Description of the Prior Art

The way of the human living and habits has been changed a lot accompanying the rise of virtual world, Internet or World Wide Web, so does the purchase behavior of the human. By means of Internet, online shopping, which is run by some websites, has been blooming. Generally, when most of the Internet users want to buy their chosen products from those online shopping websites, the websites will ask the users to upload their credit card numbers and basic information on an answer sheet shown in their web pages. After the websites confirm these data with the financial organization that issues the credit cards, they add the article costs into the credit card bills. The users will pay that credit card bill to fulfill their obligations. Such type of payment requires the users to fill in their credit card numbers and associated information. Though the data access and transmission have been encoded, if the credit card numbers are stolen by Internet hackers during the process of transmission through network, the hackers could do purchase through Internet without the users' approvals. The aftermaths are unimaginable, and the safety has been worrying.

Another way of shopping through the Internet is that the users click the products that they want to buy shown on the web pages, then the online shopping website will ask the users to specify the post offices or dispatch destination (such as food mart) for delivery. As soon as the post office or dispatch destination receives the products, it will inform the user to pick up. The user can complete the payment procedure by paying cash for the chosen products in the post office or dispatch destination. Though this payment manner can prevent credit card numbers from being stolen by hackers, it may increase hoarding space of products or financial waste for transportation. The defect of this payment method still exists in users not going to receive it or being overdue in receiving it after the products arrived.

For solving the above-mentioned defects caused from the conventional payment methods, the inventor proposes a new type of e-payment that is not only safe but also convenient.

### SUMMARY OF THE INVENTION

In accordance with the present invention, a user should apply to become a bidirectional wireless communication client and obtain a transmission authority number of the bi-directional wireless communication from a telecommunication service server first. While the users choose at least one product from a merchandise provider, they can input the transmission number to the telecommunication service server.

The feature of the invention is that when the telecommunication service server receives the transmission number, the server will return a confirmation message back to a display interface of the user's wireless communication's equipment. After the user receives the confirmation message, he will send a reconfirmation message back to the telecommunication service server. When the telecommunication service provider receives the reconfirmation message, the telecommunication service provider will total sum of the cost of the products into the phone bill and complete the whole e-payment procedure.

### BRIEF DESCRIPTION OF THE DRAWINGS

The present invention may be more easily understood by reference to the following drawings:

FIG. 1 is a schematic view of a preferred embodiment of the present invention, illustrating a connection of equipments used in the payment method according to the present invention;

FIG. 2 is a flow chart of a preferred embodiment of the present invention, illustrating procedures of the payment method for a cellular phone user according to the present invention;

FIG. 3 is a flow chart of a preferred embodiment of the present invention, illustrating procedures of the payment method for a purchasing-products-online user according to the present invention;

FIG. 4 is a schematic view of a preferred embodiment of the present invention, showing a window of a web page from an online shopping website according to the present invention;

FIG. 5 is a schematic view of a preferred embodiment of the present invention, showing that a dialog window popped up after a user selected the products;

FIG. 6 is a schematic view of another preferred embodiment of the present invention, illustrating another way to connect equipments for the payment method according to the present invention.

### DETAILED DESCRIPTION OF THE INVENTION

The present invention relates to an e-payment method through Internet or a store, which is real or virtual. By use of bi-directionally transmittable wireless equipment, we can select merchandise after surveying the relative information about this merchandise shown on a web page. The invention provides not only a function on offering people to purchase through network but also a new method for people to shop and pay the bill through the network service which were provided from a telecommunication service provider and an online website.

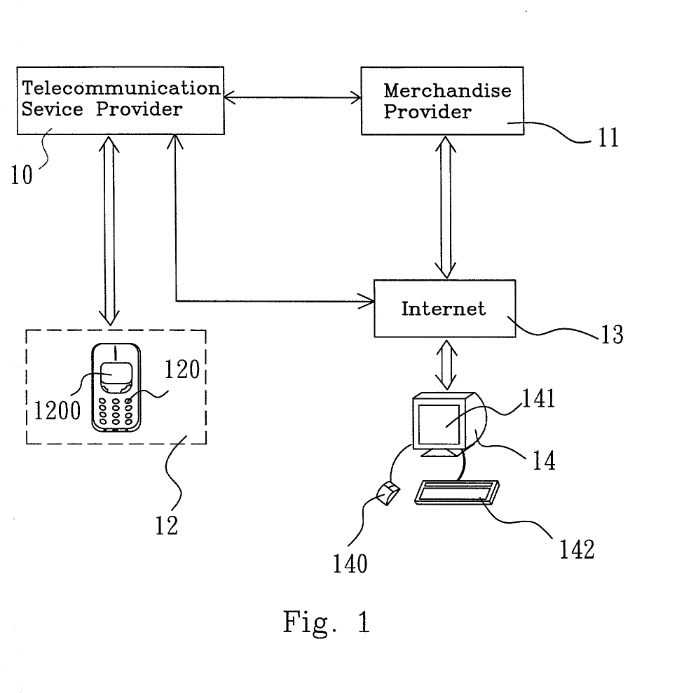

A schematic view of a preferred embodiment of the invention is shown in FIG. 1. Here, a merchandise provider 11, which is an online shopping website, can be browsed by a user 12 through the Internet 13 by using a personal computer 14 or through a telecommunication service provider 10 connected with the Internet 11. The telecommunication service provider 10 provides a transmission number for a bi-directionally transmittable wireless communication equipment, the wireless communication equipment transmission number in the embodiment is a cellular phone number. The telecommunication service provider 10 also offers other telecommunication service related. Each user 12 has a cellular phone 120 which transmits and receives signals through the telecommunication service provider 10. And, the personal computer 14 includes a mouse 140, a monitor 141 and a keyboard 142.

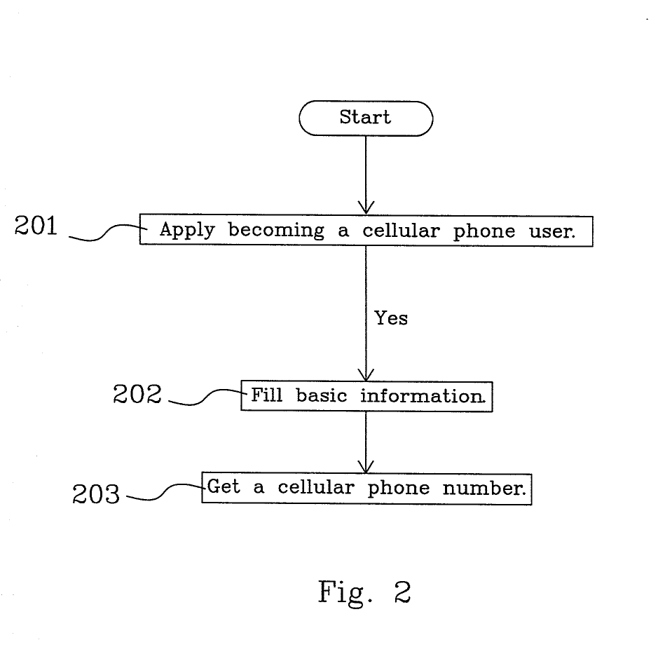

FIG. 2 is a flow chart showing how to apply to become a cellular phone user. In the beginning, a user applies to become a cellular phone user 201 of a telecommunication service provider which cooperates with an online shopping website. The first procedure for one to apply to become a cellular phone user is required to fill basic information 202 in an application form required to join for online shopping. In the embodiment, the basic information includes the home address and the way of delivery. After the application is verified, and the applicant is allowed to become a cellular phone user of the telecommunication service provider, the user receives a cellular phone number (transmission number) 203 issued from the telecommunication service provider.

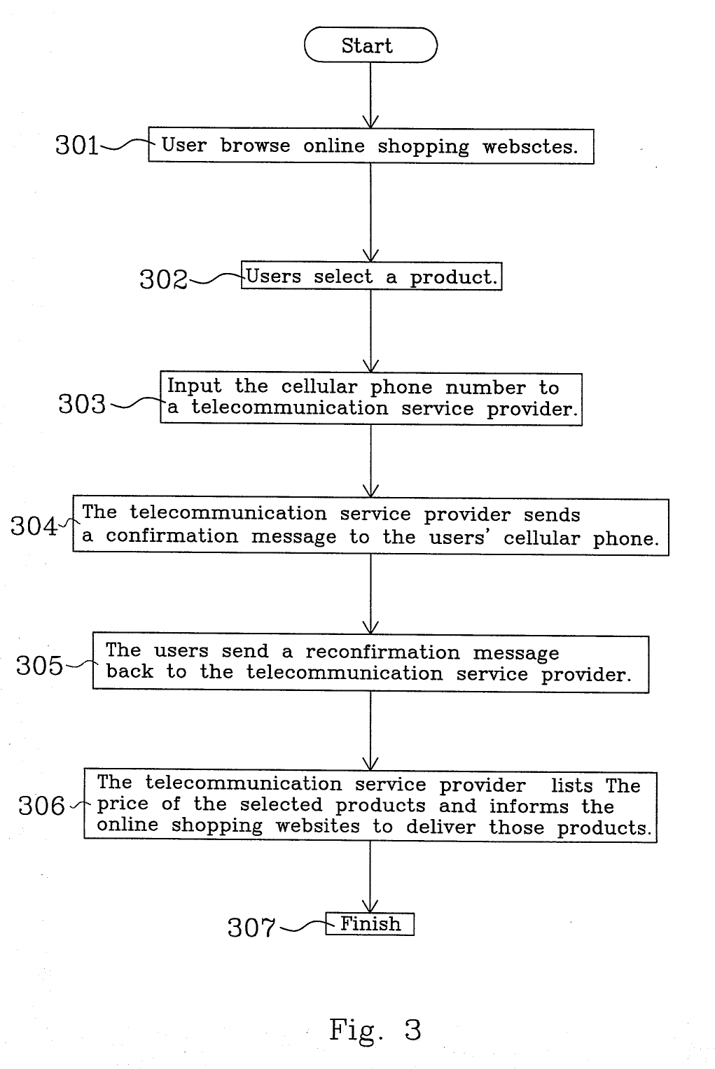

The procedure of the e-payment for a user's purchase through the online network is shown as FIG. 3. In the beginning, the user starts browsing online shopping websites of Internet through a computer (step 301). After the user decides to buy a product from the online shopping websites (step 302), he inputs the cellular phone number to a telecommunication service provider (step 303). The telecommunication service provider receives this cellular phone number and sends a confirmation message that will be shown on the screen of the user's phone to the user for verification (step 304). After the confirmation message is received, the user returns a reconfirmation message to the telecommunication service provider to prove the purchase (step 305). Then, the telecommunication service provider lists the price of the selected product on a phone bill and informs the online shopping websites to deliver the product according to the basic data filled in the application form when it receives this reconfirmation message (step 306). When the user receives the product he selected, this e-payment for purchase is completed (step 307). When the user receives the phone bill from the telecommunication service provider, he pays the phone bill, which the price of the merchandise is included, as usual.

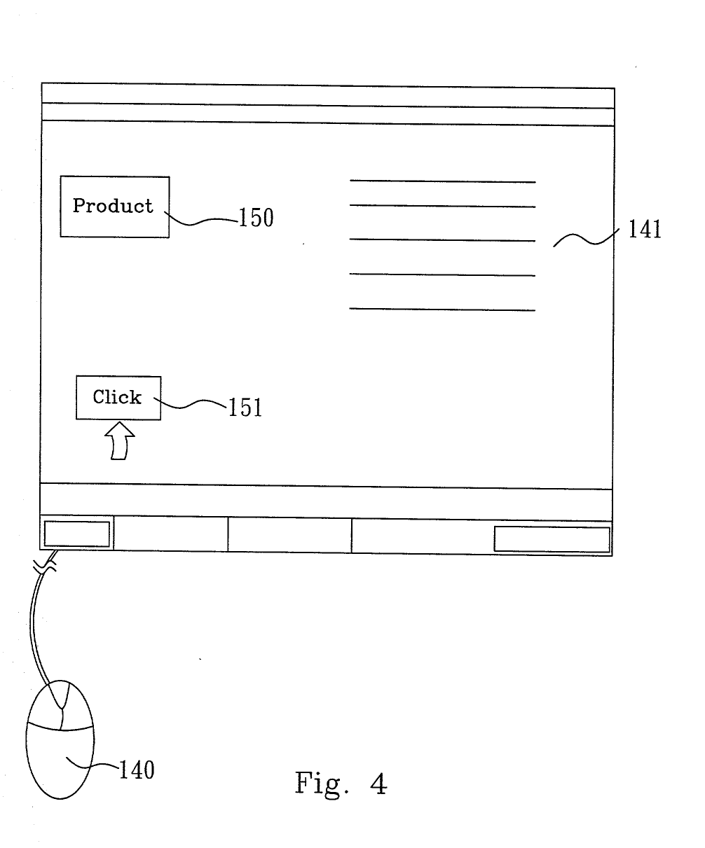

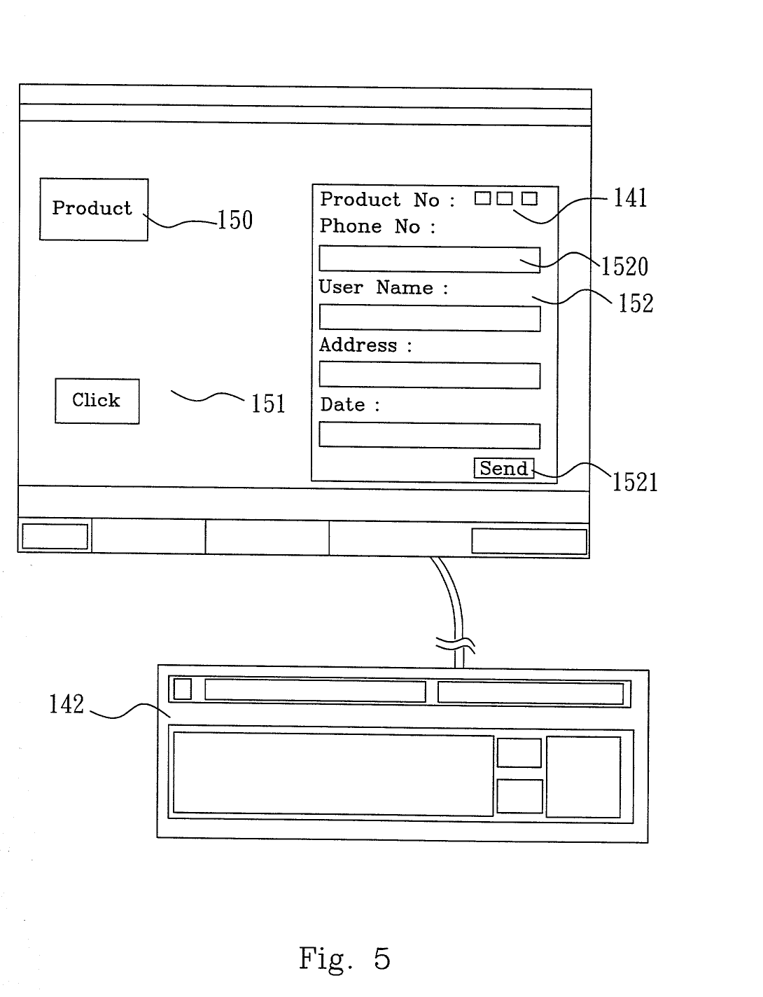

Moreover, how to process a purchase on a window in a web page of an online shopping website is shown in FIG. 4. After browsing a window 141 shown on a computer's monitor through Internet. The user selects a product 150 by clicking a mouse 140 on a corresponding “purchase” button 151. Then, a dialog window 152 will be popped out on the computer monitor, as shown in FIG. 5. This dialog window 152 includes a dialog boxes 1520 that the user's phone number, name, address and etc. are shown, besides, it shows the selected product's name and other information. After the user fills all the information in the boxes 1520 through a keyboard 142, pushes a “SEND” button, the user then can receive an immediate message soon, and processes the above-mentioned payment procedure.

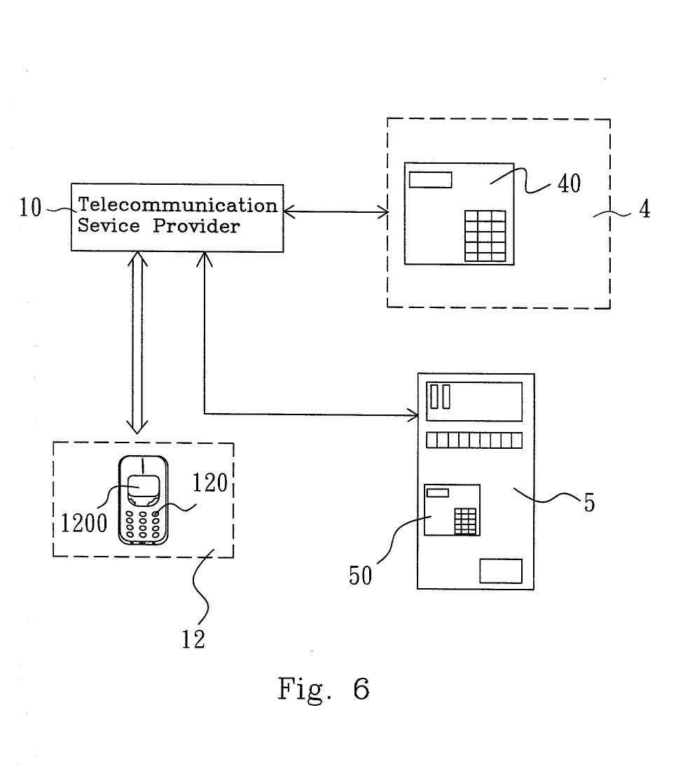

Furthermore, please refer to FIG. 6, illustrating a schematic view of another embodiment of the present invention. An e-payment method can be used through a normal store 4, such as department stores, and a store without employee, such as a vending machine 5. The both normal store 4 and vending machine 5 have to be connected with the telecommunication service provider 10. And, the normal store 4 and vending machine have communication equipments 40 and 50 respectively.

When a user decide to buy a particular item at the normal store 4 or the vending machine 5, the clerk or sales person can send the product data to the user's cellular phone and the telecommunication service provider 10 concurrently via the communication equipment 40, 50. Once the telecommunication service provider 10 receives the user's cellular phone number, it will, then, send one confirmation briefing to a user's cellular phone screen 1200 (display interface). After the user 12 receives and verifies this confirmation, the user 12 sends back a reconfirmation message to the telecommunication service provider 10. The telecommunication service provider 10 receives the user's message, and sends back a message of transaction completion to the communication equipment 40 and adds the cost of the item to the cellular phone's bill. Once the user receives the bill from the telecommunication service provider 10, the user then pay the bill as usual.

A user 12 can encode a set of password in addition to the cellular phone number (in order to prevent anyone who knows the number from tricking the user) after chooses an article at the vending machine 5. The user 12 inputs the encoded cellular phone number to the communication equipment 40, 50 and the telecommunication service provider 10. After the telecommunication service provider 10 receives the user's encoded cellular phone number, the telecommunication service provider 10 sends a confirmation briefing to the user's cellular phone screen 1200. When the user receives and verifies the confirmation, then sends back a reconfirmation message to the telecommunication service provider 10. When the telecommunication service provider 10 receives the message that is returned from this user 12, then sends back a message of completion of transaction to communication equipment 50 of that particular vending machine 5. The cost will be added to the user's cellular phone bill and accomplish this transaction process. When the user receives the bill from the telecommunication service provider 10, he can pay the bill as usual.

It may thus be seen that the objects of the present invention set forth herein, as well as those made apparent from the foregoing description, are efficiently attained. While the preferred embodiment of the invention has been set forth for purpose of disclosure, modifications of the disclosed embodiment of the invention as well as other embodiments thereof may occur to those skilled in the art. Accordingly, the appended claims are intended to cover all embodiments that do not depart from the spirit and scope of the invention

What is claimed is:

1. An e-payment method for purchase, used in a merchandise provider and a telecommunication service provider connected with said merchandise provider, comprising:
applying to become a user of a bi-directional wireless communication equipment of said telecommunication service provider, and obtaining a transmission number of said bidirectional wireless communication equipment;
selecting at least one product from said merchandise provider;
inputting and sending said transmission number to said telecommunication service provider;
sending a confirmation briefing to a display interface of said bi-direction wireless communication equipment after said telecommunication service provider receives said transmission number;
sending back a reconfirmation message to said telecommunication service provider after the user receives and verifies said confirmation briefing;
adding cost of a product into a phone bill of said wireless communication equipment when said telecommunication service provider receiving the reconfirmation message; and completing the purchase.

2. The method of claim 1, wherein said the user selects at least one product from said merchandise provider, said merchandise provider is an online shopping website, and said user uses a personal computer to purchase online and selects products.

3. The method of claim 1, wherein said user selects at least one product from said merchandise provider, said merchandise provider is a store with clerks and has said communication equipment connected with said telecommunication service provider.

4. The method of claim 1, wherein said user selects at least one product from said merchandise provider, said merchandise provider is an unmanned vending equipment having said communication equipment connected with said telecommunication service provider.

5. The method of claim 1, wherein said bi-directional wireless communication equipment is a cellular phone; and said transmission number is a cellular number.

6. The method of claim 1, wherein after said user clicks on a corresponding “purchase” button for said product on the computer screen, a website having a dialog window is popped out and asks the user to input the transmission number at the step of said selecting at least one product from the merchandise provider.

7. The method of claim 1, wherein said confirmation briefing lists said product's name and the selected merchandise's price.

8. An e-payment method for purchase, being used in a merchandise provider and a telecommunication service provider connected to said merchandise provider, wherein an user applies to become a user of a bi-directional wireless communication equipment of said telecommunication service provider, then obtains a transmission number from said bi-directional wireless communication equipment; next, said user selects at least one product from said merchandise provider and inputs and sends said transmission number to said telecommunication service provider, comprising steps of:
receiving said transmission number and sending a confirmation briefing immediately to an user's wireless communication equipment's display interface from said telecommunication service provider;
receiving and verifying said confirmation briefing, then sending a reconfirmation message back to said telecommunication service provider from said user; and
receiving said reconfirmation message by said telecommunication service provider, and adding a cost of said product into a phone bill of said wireless communication equipment.

9. The method of claim 8, wherein said merchandise provider is an online shopping website, and said user selects a product by means of a personal computer and purchases said product through said online shopping website.

10. The method of claim 8, wherein said merchandise provider is a store with clerks, and has said communication equipment connected to said telecommunication service provider.

11. The method of claim 8, wherein said merchandise provider is an unmanned vending equipment having said communication equipment connected to said telecommunication service provider.

12. The method of claim 8, wherein said bi-directional wireless communication equipment is a cellular phone; and said transmission number is a cellular phone number.

13. T The method of claim 8, wherein after said user clicks on a corresponding “purchase” button for said product on the computer screen, a website having a dialog window is popped out and asks the user to input said transmission number at the step of said selecting at least one product from said merchandise provider.

14. The method of claim 1, wherein said confirmation message lists said selected product's name and price.
